(19) United States
(12) Patent Application Publication
(10) Pub. No.: US 2022/0331912 A1
(43) Pub. Date: Oct. 20, 2022

(54) AUTOMATIC WELDING SYSTEM, AUTOMATIC WELDING METHOD, WELDING ASSISTANCE DEVICE, AND PROGRAM

(71) Applicant: KABUSHIKI KAISHA KOBE SEIKO SHO (KOBE STEEL, LTD.), Hyogo (JP)

(72) Inventors: Keita OZAKI, Kobe-shi (JP); Akira OKAMOTO, Kobe-shi (JP); Naohide FURUKAWA, Fujisawa-shi (JP)

(73) Assignee: KABUSHIKI KAISHA KOBE SEIKO SHO (KOBE STEEL, LTD.), Hyogo (JP)

(21) Appl. No.: 17/633,132

(22) PCT Filed: Oct. 12, 2020
(86) PCT No.: PCT/JP2020/038535

§ 371 Date: Feb. 4, 2022

(30) Foreign Application Priority Data
Nov. 19, 2019 (JP) 2019-208569
Aug. 18, 2020 (JP) 2020-137800

(51) Int. Cl. B23K 31/12; B23K 9/127; B23K 9/095; B23K 9/02; B25J 9/16; B25J 11/00; B23K 37/02

(52) U.S. Cl. CPC B23K 31/125; B23K 9/127; B23K 9/0956; B23K 9/02; B25J 9/1697; B25J 11/005; B23K 37/0282

(57) ABSTRACT

An automatic welding system, an automatic welding method, a welding assistance device, and a program wherein the amount of correction of the welding speed is determined on the basis of the distance between an arc and the tip of a molten pool when the distance between the arc and the tip of the molten pool is within a predetermined range in arc welding performed while alternately weaving a welding torch in the front downward direction and the rear upward direction when the welding progress direction is the frontward direction with respect to a horizontally extending groove formed between two members to be welded aligned in the vertical direction.

### TECHNICAL FIELD

The present invention relates to an automatic welding system, an automatic welding method, a welding assistance device, and a program.

### BACKGROUND ART

Patent Literature 1 discloses a technique which involves moving a tip of a welding wire along a groove while weaving the tip of the welding wire between an upper end and a lower end of the groove, stopping the travel of a welding torch in the process of weaving the tip of the welding wire from the lower end to the upper end of the groove, stopping the weaving of the tip of the welding wire at the upper end of the groove, reducing the amount of power supplied to the welding wire while moving the welding torch, and increasing the travel speed of the welding torch, the weaving speed of the tip of the welding wire, and the amount of power supplied to the welding wire in the process of weaving the tip of the welding wire from the upper end to the lower end of the groove.

The technique described in Patent Literature 1 involves varying the travel speed of the welding torch, the weaving speed of the welding wire, and the amount of power supplied to the welding wire. However, Patent Literature 1 does not concern a positional relation to a molten pool. This means that the welding torch or the welding wire may move ahead of, or lag behind, the molten pool that often changes its range.

### CITATION LIST

### Patent Literature

PTL 1: Japanese Unexamined Patent Application Publication No. 2017-6968

### SUMMARY OF INVENTION

The present invention has been made in view of the circumstances described above. An object of the present invention is to provide an automatic welding system, an automatic welding method, a welding assistance device, and a program that are capable of enabling, in horizontal welding, a welding torch to be kept at a proper position with respect to a molten pool.

In arc welding performed in a groove while a welding torch is being weaved in a front downward direction and a rear upward direction in an alternating manner when a welding direction is a frontward direction, an automatic welding system, an automatic welding method, a welding assistance device, and a program according to the present invention determine the amount of correction of welding speed on the basis of a distance between an arc and a leading end of a molten pool when the distance is in a predetermined range. The groove extends in a horizontal direction between two workpieces to be welded which are aligned in a vertical direction.

The foregoing and other objects, features, and advantages of the present invention will be apparent from the following detailed description and the accompanying drawings.

### BRIEF DESCRIPTION OF DRAWINGS

FIG. 1 is a diagram illustrating an example of welding performed by an automatic welding system according to an embodiment.

FIG. 2 is a diagram illustrating an example of a configuration of the automatic welding system.

FIG. 3 is a diagram illustrating an example of an image of a molten pool captured by a camera.

FIG. 4 is a diagram schematically illustrating an example of a molten pool.

FIG. 5 is a diagram illustrating an example of data sets used in a learning phase.

FIG. 6 is a flowchart illustrating an example of a procedure in the learning phase.

FIG. 7 is a diagram for explaining the learning phase.

FIG. 8 is a flowchart illustrating an example of a procedure in an inference phase.

FIG. 9 is a diagram for explaining the inference phase.

FIG. 10 is a schematic diagram qualitatively illustrating how LeadX and dY change with time.

FIG. 11 is a diagram illustrating an example of adjustment of a weaving angle.

FIG. 12 is a flowchart illustrating an example of a procedure of a process according to a first modification.

FIG. 13 is a diagram for explaining the process.

FIG. 14 is a diagram for explaining another modification.

FIG. 15 is a flowchart illustrating an example of a procedure of a process according to a second modification.

FIG. 16 is a diagram for explaining the process.

### DESCRIPTION OF EMBODIMENTS

An embodiment of the present invention will now be described on the basis of the drawings. Throughout the drawings, the same components are designated by the same characters and the description thereof will be omitted as appropriate. In the present description, components collectively referred to are designated by reference characters without subscripts, whereas components individually referred to are designated by reference characters with subscripts.

### [System Overview]

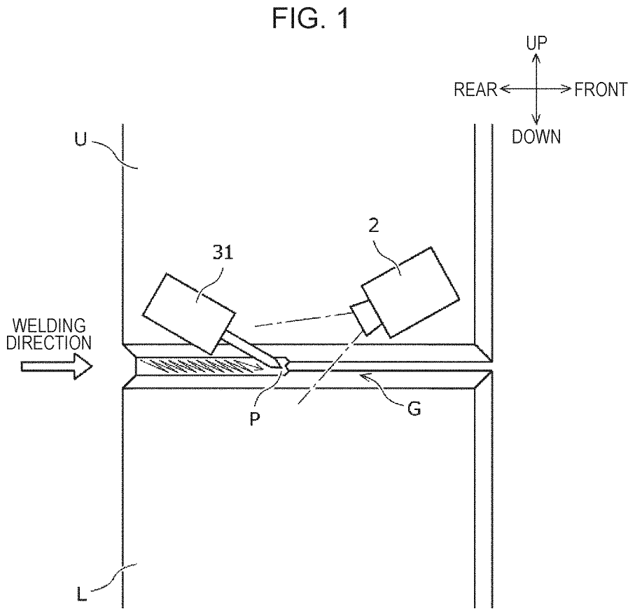

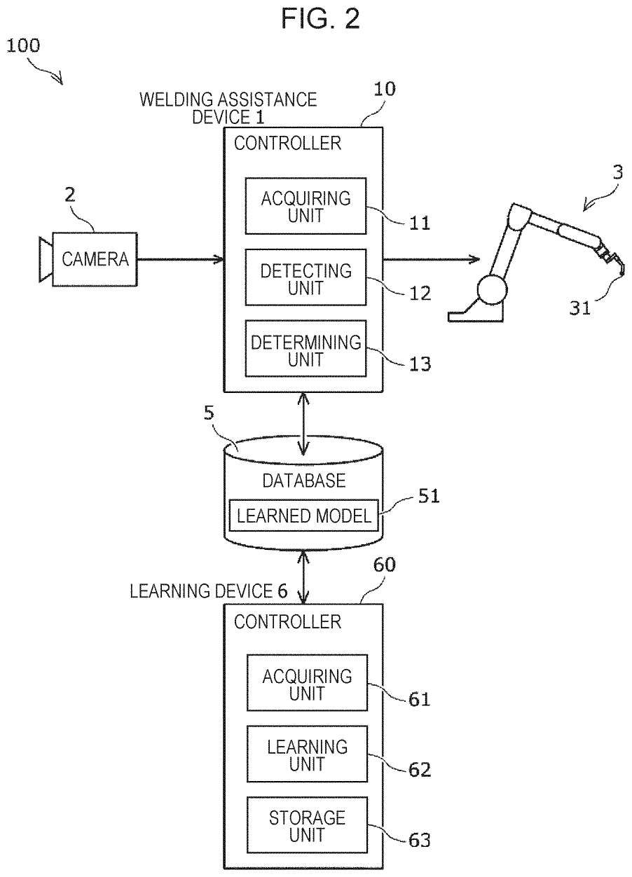

FIG. 1 is a diagram illustrating an example of welding performed by an automatic welding system 100 according to an embodiment. FIG. 2 is a diagram illustrating an example of a configuration of the automatic welding system 100.

A welding robot 3 included in the automatic welding system 100 performs arc welding while moving a welding torch 31 in a frontward direction (welding direction) in a groove G extending in a horizontal direction (front-rear direction) between two workpieces U and L to be welded (hereinafter referred to as workpieces U and L) aligned in a vertical direction (up-down direction). A molten pool P is formed near the tip of the welding torch 31.

The gap between the workpieces U and L (i.e., width of the groove G) is, for example, about 3 mm to 10 mm. The workpieces U and L may or may not be provided with a backing member attached thereto. The shape of the groove G is not limited to a V shape shown. The groove G may have an X-shape or other shapes.

The arc welding is, for example, tungsten inert gas (TIG) welding, or may be, for example, metal inert gas (MIG) welding or metal active gas (MAG) welding.

The welding robot 3 performs arc welding while weaving the welding torch 31 in a front downward direction and a rear upward direction in an alternating manner. This motion, which simulates manipulation of electrode by a highly skilled welder, aims to reduce sagging of the molten pool P.

The camera 2 captures an arc produced at the tip of the welding torch 31 and the molten pool P to generate an image. The camera 2 also captures an image of a wire (filler metal) (not shown) fed toward the arc. The camera 2 is disposed frontward of the welding torch 31 and moves together with the welding torch 31 in the frontward direction. To restrict entry of arc light, a bandpass filter that transmits only near infrared light of about 950 nm is attached to a lens of the camera 2. The camera 2 is a video camera configured to generate a video image containing a plurality of time-series still images (frames). The camera 2 is not limited to this. The camera 2 may be a still camera configured to generate a plurality of time-series still images through periodic photographing.

As illustrated in FIG. 2, the automatic welding system 100 includes a welding assistance device 1, the camera 2, the welding robot 3, a database 5, and a learning device 6, which are capable of communicating with each other through a communication network, such as the Internet or a LAN.

The welding assistance device 1 includes a controller 10. The controller 10 is a computer that includes, for example, a central processing unit (CPU), a random access memory (RAM), a read only memory (ROM), a non-volatile memory, and an input/output interface. The CPU of the controller 10 executes information processing in accordance with a program loaded from the ROM or non-volatile memory into the RAM.

The controller 10 includes an acquiring unit 11, a detecting unit 12, and a determining unit 13. These functional units are implemented when the CPU of the controller 10 executes information processing in accordance with a program loaded from the ROM or non-volatile memory into the RAM. For example, the program may be supplied through an information storage medium, such as an optical disk or a memory card, or may be supplied through a communication network, such as the Internet or a LAN.

The learning device 6 includes a controller 60, similarly to the welding assistance device 1. The controller 60 includes an acquiring unit 61, a learning unit 62, and a storage unit 63. The learning device 6 may be constituted by one or more server computers.

The database 5 is accessible from the welding assistance device 1 and the learning device 6. A learned model 51 built by the learning device 6 is stored in the database 5 in such a way that it can be read by the welding assistance device 1.

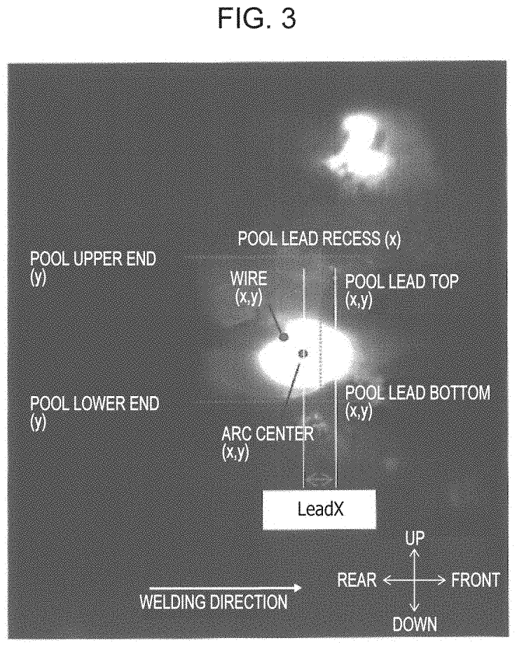

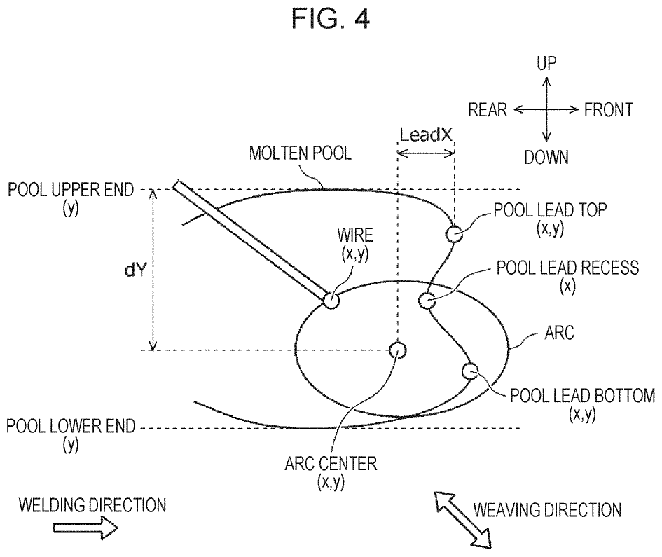

FIG. 3 is a diagram illustrating an example of an image of a molten pool captured by the camera 2. FIG. 4 is a diagram schematically illustrating an example of a molten pool. In FIG. 3, a lower protrusion at the leading end of the molten pool is not visible due to obstruction by arc light. In these drawings, x represents a position in the front-rear direction and y represents a position in the up-down direction.

As illustrated in these drawings, the leading end of the molten pool has two protrusions (upper and lower protrusions) positioned one above the other and protruding frontward, and a recess recessed rearward between the two protrusions. Due to sagging of the molten pool, the tip of the lower protrusion is located frontward of the tip of the upper protrusion.

Poor welding may result if the welding torch moves ahead of, or lags behind, the molten pool. It is thus important to keep the welding torch at a proper position with respect to the molten pool.

However, due to the influence of various factors, such as welding distortion and installation error, the groove width and the weld line may deviate from design values. Since this may change the accumulation conditions of the molten pool, it is not easy to keep the welding torch at a proper position with respect to the molten pool. This is particularly so when the welding torch is weaved in directions including the welding direction.

In the present embodiment, as described below, the amount of correction of welding speed is determined on the basis of a camera image. This makes it possible to keep the welding torch at a proper position with respect to the molten pool.

### [Learning Phase]

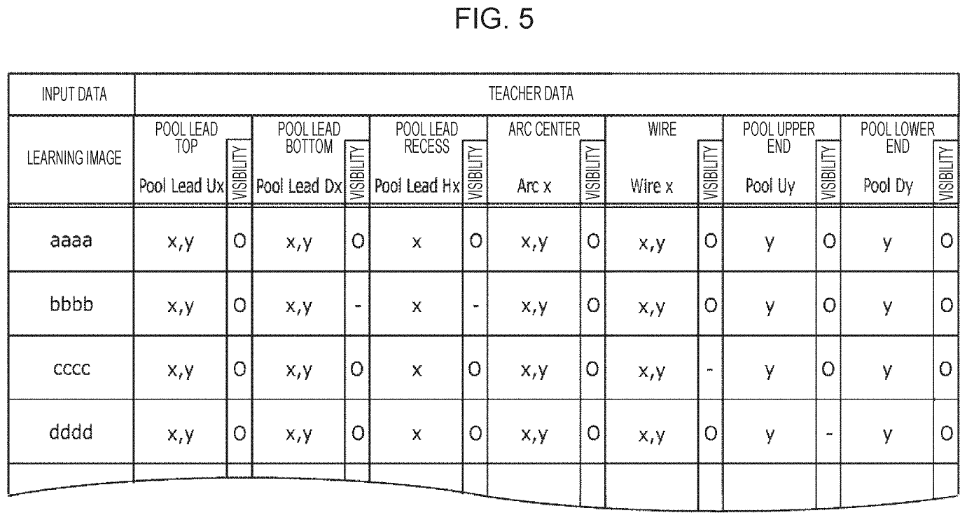

FIG. 5 is a diagram illustrating an example of data sets used in a learning phase. The data sets include input data and teacher data. The input data is a learning image. The learning image may be, for example, an image captured by the camera 2, or may be an image captured by another camera. The teacher data includes values representing the positions of feature points in the learning image. Specifically, there are seven feature points including a pool lead top (tip of the upper protrusion), a pool lead bottom (tip of the lower protrusion), a pool lead recess (rear end of the recess), an arc center, a wire, a pool upper end, and a pool lower end (see FIG. 3 and FIG. 4). Of the positions of the seven feature points, the positions of the pool lead top, the pool lead bottom, the arc center, and the wire are represented by coordinates in the x direction (front-rear direction) and the y direction (up-down direction). The position of the pool lead recess is represented by a coordinate in the x direction alone. The positions of the pool upper end and the pool lower end are represented by coordinates in the y direction alone. That is, there are a total of 11 values for the positions of the feature points. The teacher data also includes a flag indicating the visibility of each feature point in the learning image. The visibility of each feature point is indicated by one of two values, good (O) or bad (-). That is, there are a total of seven values for the visibility. For example, in the image illustrated in FIG. 3, the pool lead bottom (feature point) is not visible because it is obstructed by arc light. The position and visibility of each feature point included in the teacher data are determined, for example, by a skilled welder checking the learning image, and are entered, for example, using a pointing device.

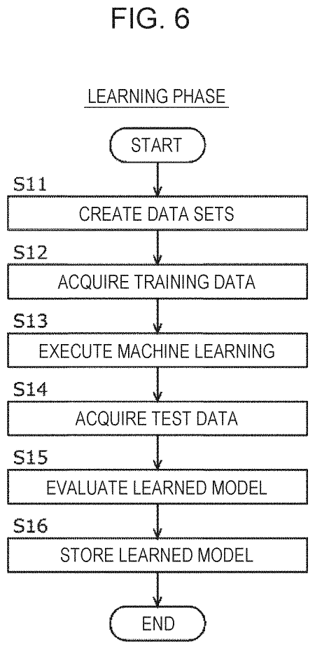

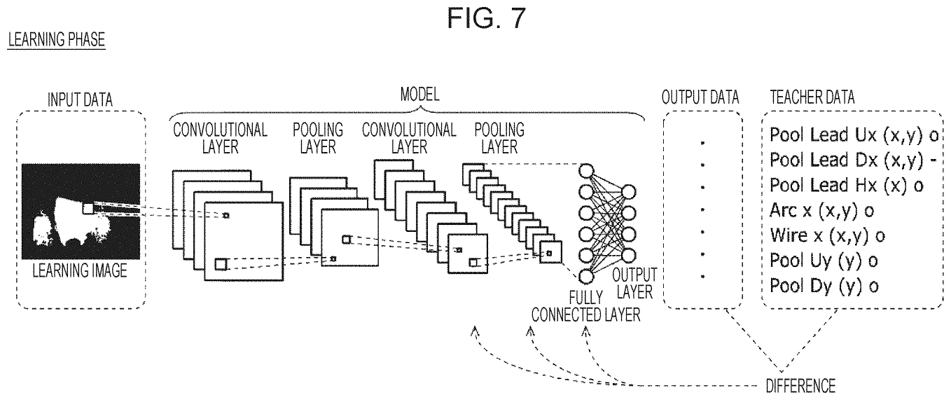

FIG. 6 is a flowchart illustrating an example of a procedure in a learning phase implemented by the learning device 6. By executing the process illustrated in this drawing in accordance with a program, the controller 60 of the learning device 6 functions as the acquiring unit 61, the learning unit 62, and the storage unit 63. FIG. 7 is a diagram for explaining the learning phase.

First, the controller 60 creates many data sets including a learning image and positional coordinates of each feature point and a visibility flag of each feature point (see S11 in FIG. 5).

Next, the controller 60 acquires some of the data sets as training data (S12; operation of the acquiring unit 61).

Next, the controller 60 executes machine learning using the acquired training data (S13; operation of the learning unit 62). Specifically, by using the learning image as input data and using the positional coordinates and the visibility flag of each feature point as teacher data, the controller 60 builds, through machine learning, a learned model for estimating the positional coordinates and accuracy of each feature point from an image.

The model is, for example, a convolutional neural network that includes a convolutional layer, a pooling layer, a fully connected layer, and an output layer. It is particularly preferable to use a deep neural network that combines multiple layers of neurons. The output layer includes elements each corresponding to the positional coordinates and the visibility flag of each feature point. That is, the output layer includes a total of 11 elements for the positions of the feature points and a total of 7 elements for the visibility of the feature points. For example, an identity function is used for the elements for the positions of the feature points. For the elements for visibility, for example, a softmax function is used, and an output value represented by a real number between 0 and 1 can be used as a value indicating the accuracy of the feature point. Specifically, the controller 60 inputs the learning image into the model, performs calculation, outputs the positional coordinates and accuracy of each feature point as output data from the model, calculates the difference between the output data and the teacher data, and performs learning in such a way as to reduce the difference.

Next, the controller 60 acquires, as test data, another data set different from the training data (S14), and evaluates the learned model using the acquired test data (S15).

Then, if the evaluated learned model is at a predetermined level or above, the controller 60 stores the learned model in the database 5 (S16) and ends the learning phase.

The convolutional neural network illustrated is merely an example, and the layer structure is not limited to this. The number of convolutional, pooling, and fully connected layers may differ from that shown. Instead of machine learning, another technique, such as pattern matching, may be used to detect feature points.

### [Inference Phase]

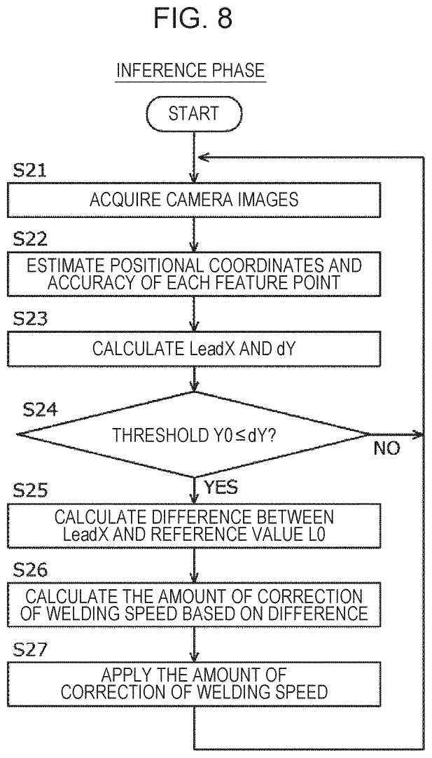

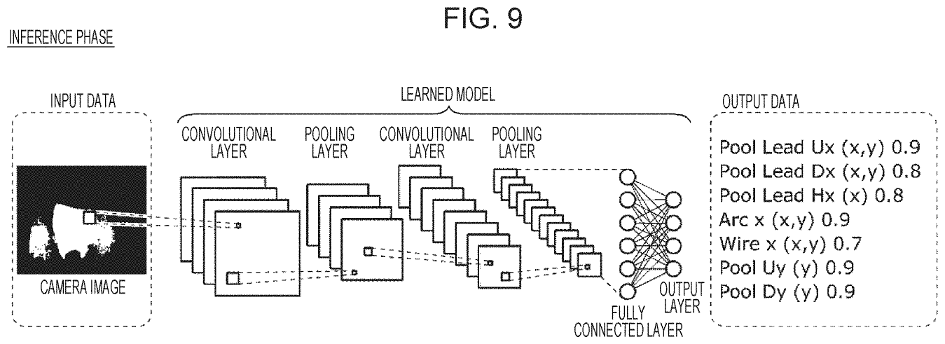

FIG. 8 is a flowchart illustrating an example of a procedure in an inference phase implemented by the welding assistance device 1. The procedure in the inference phase corresponds to an automatic welding method according to an embodiment. By executing the process illustrated in this drawing in accordance with a program, the controller 10 of the welding assistance device 1 functions as the acquiring unit 11, the detecting unit 12, and the determining unit 13. FIG. 9 is a diagram for explaining the inference phase.

First, the controller 10 acquires camera images from the camera 2 (S21; operation of the acquiring unit 11). Specifically, the controller 10 sequentially acquires, as camera images, a plurality of time-series still images (frames) contained in a video image generated by the camera 2.

Next, the controller 10 estimates the positional coordinates and accuracy of each feature point in the camera image using a learned model built in the learning phase (S22; operation of the detecting unit 12). Specifically, the controller 10 inputs, as input data, the plurality of time-series camera images into the learned model in sequence, performs calculation, and outputs the positional coordinates and accuracy of each feature point. As described above, there are seven feature points including the pool lead top (tip of the upper protrusion), the pool lead bottom (tip of the lower protrusion), the pool lead recess (rear end of the recess), the arc center, the wire, the pool upper end, and the pool lower end (see FIG. 3 and FIG. 4). The accuracy of each feature point is represented by a real number between 0 and 1.

Next, the controller 10 calculates a distance LeadX between the arc and a leading end of the molten pool and a distance dY between the arc and the upper end of the molten pool (S23). Specifically, the distance LeadX is the distance between the arc center and a leading end of the molten pool in the x direction (front-rear direction). The leading end of the molten pool, used to define the distance LeadX, is any one of the pool lead top, the pool lead bottom, and the pool lead recess. The pool lead bottom is located at the foremost position due to sagging of the molten pool, and may not be visible due to obstruction by arc light. Accordingly, it is preferable to use the pool lead top or the pool lead recess located above the pool lead bottom. It is particularly preferable to use the pool lead top which is located at the uppermost position and has high visibility. That is, it is preferable that the distance LeadX be a distance between the arc center and the pool lead top in the x direction (see FIG. 4). The distance dY is a distance between the arc center and the pool upper end in the y direction (up-down direction). The distance dY is not limited to this and may be a distance between the arc center and the pool lower end in the y direction.

If the accuracy of any feature point used to calculate the distance LeadX and the distance dY is less than or equal to a threshold, the calculation of the distance LeadX and the distance dY is skipped.

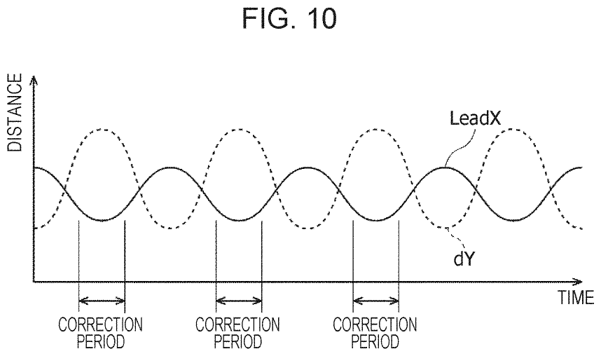

FIG. 10 is a schematic diagram qualitatively illustrating how the distance LeadX and the distance dY change with time. The distance LeadX and the distance dY change periodically by weaving of the welding torch 31. The distance LeadX and the distance dY have a phase difference of 180°. Specifically, when the distance LeadX is in the closest range (or at a so-called trough) or when the arc center is close to the leading end of the molten pool, the distance dY is in the farthest range (or at a so-called crest) or the arc center is away from the pool upper end. On the other hand, when the distance LeadX is in the farthest range (or at a so-called crest) or when the arc center is away from the leading end of the molten pool, the distance dY is in the closest range (or at a so-called trough) or the arc center is close to the pool upper end. Note that the closest range refers to the range of a predetermined width including the closest point at the center, and the farthest range refers to the range of a predetermined width including the farthest point at the center.

Thus, since the distance LeadX periodically changes as described above, the amount of correction of welding speed cannot be calculated simply by using the distance LeadX. Accordingly, in the present embodiment, the amount of correction of welding speed is calculated when the distance LeadX is in a predetermined range. Specifically, in the present embodiment, the amount of correction of welding speed is calculated when the distance LeadX is in the closest range. In other words, the amount of correction of welding speed is calculated when the distance dY is in the farthest range.

To achieve this, as illustrated in FIG. 8, after calculating the distance LeadX and the distance dY (S23), the controller 10 determines whether the distance dY is greater than or equal to a threshold Y0 (S24) to determine whether the distance dY is in the farthest range. The threshold Y0 is set such that distance dY greater than or equal to the threshold Y0 falls within the farthest range. If the distance dY is greater than or equal to the threshold Y0 (S24: YES), the controller 10 calculates the difference between the distance LeadX and a reference value L0 and calculates the amount of correction of welding speed on the basis of the calculated difference (S25, S26; operation of the determining unit 23). The reference value L0 is set to an optimum value for the distance LeadX, that is, to a value at which a penetration bead of highest quality can be produced. The amount of correction of welding speed ΔV is calculated by multiplying the difference ΔL between the distance LeadX and the reference value L0 by a predetermined transformation coefficient β. This can be expressed as ΔV=ΔL×β. Note that the welding speed is a speed at which the welding torch 31 travels in the welding direction (excluding changes caused by weaving).

Next, the controller 10 applies the calculated amount of correction of welding speed (527). Specifically, the controller 10 outputs the calculated amount of correction of welding speed to the welding robot 3 (see FIG. 2). The controller of the welding robot 3 corrects the welding speed using the amount of correction of welding speed received from the welding assistance device 1.

In the embodiment described above, in horizontal welding which involves weaving of the welding torch 31 in directions including the welding direction (frontward direction), the welding torch 31 can be kept at a proper position with respect to the molten pool P. This makes it possible to achieve high quality automatic welding.

In the embodiment described above, the controller 10 calculates the amount of correction of welding speed when the distance LeadX is in the closest range. However, the configuration is not limited to this. For example, the controller 10 may calculate the amount of correction of welding speed when the distance LeadX is in the farthest range or in the middle range (near the center of amplitude).

In the embodiment described above, the controller 10 determines whether the distance dY is in the farthest range to determine whether the distance LeadX is in the closest range. Alternatively, the determination as to whether the distance LeadX is in the closest range may be directly made. Note however that using the distance dY between the arc center and the pool upper end having high visibility enables more accurate determination.

Although the controller 10 uses the distance dY between the arc center and the pool upper end in the embodiment described above, the configuration is not limited to this. The controller 10 may use the distance between the arc center and the pool lower end and determine whether this distance is in the closest range to determine whether the distance LeadX is in the closest range.

In the embodiment described above, the controller 10 estimates the positional coordinates of the arc center from the camera image. However, the configuration is not limited to this. For example, the controller 10 may determine the positional coordinates of the arc center on the basis of positional data of the welding torch 31 provided by the controller of the welding robot 3.

Although embodiments of the present invention have been described, the present invention is not limited to the embodiments described above. Various changes can be made to the present invention by those skilled in the art.

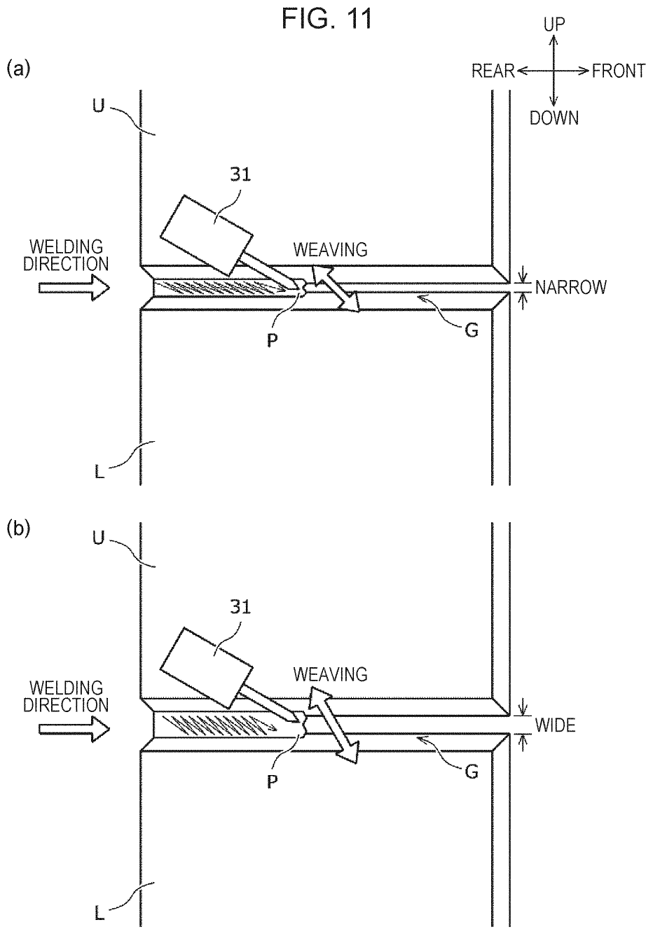

FIG. 11 is a diagram illustrating an example of adjustment of a weaving angle. FIG. 11A illustrates an example where the width of the groove G is relatively narrow, and FIG. 11B illustrates an example where the width of the groove G is relatively wide.

For example, as illustrated in FIG. 11, the controller 10 of the welding assistance device 1 may adjust the weaving angle or the weaving amplitude of the welding torch 31 on the basis of the width of the groove G (operation of an adjusting unit). For example, the controller 10 may adjust the weaving direction and the weaving amplitude in such a way that the narrower the width of the groove G as illustrated in FIG. 11A, the closer the weaving direction is to the front-rear direction and the smaller the weaving amplitude, whereas the wider the width of the groove G as illustrated in FIG. 11B, the closer the weaving direction is to the up-down direction and the greater the weaving amplitude. The width of the groove G is acquired, for example, by extracting the edge of the workpieces U and G from the camera image. However, the configuration is not limited to this. For example, the distance between the pool upper end and the pool lower end in the y direction (up-down direction) estimated in S22, may be acquired as a value corresponding to the width of the groove G.

### [First Modification]

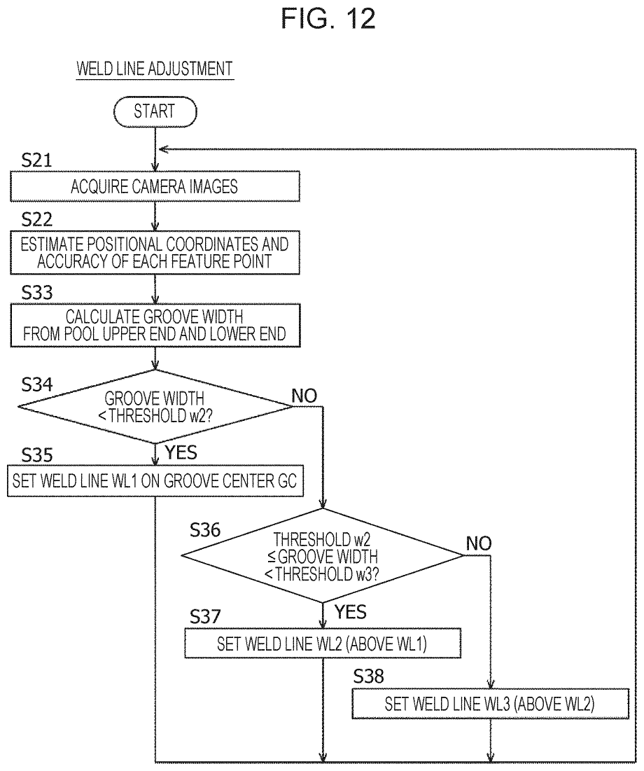

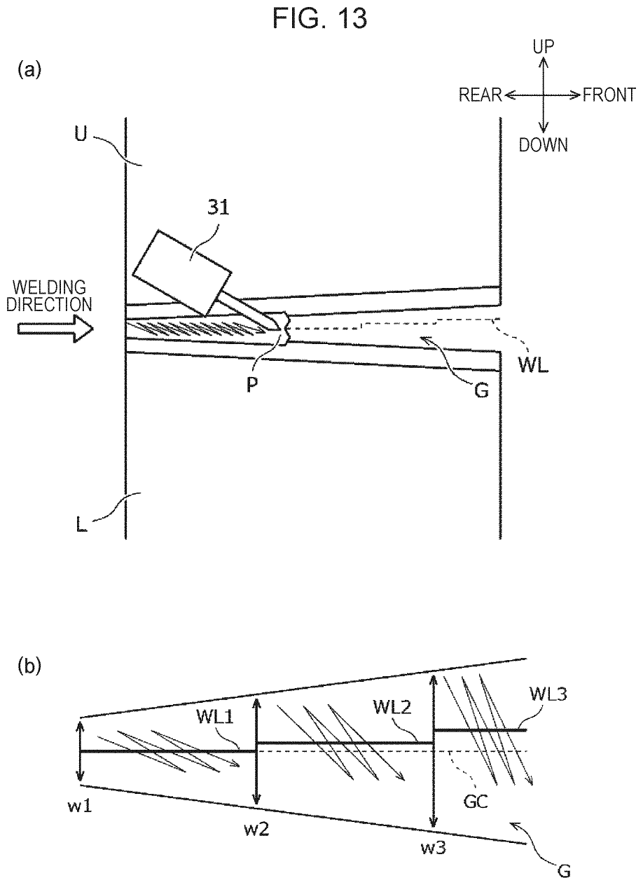

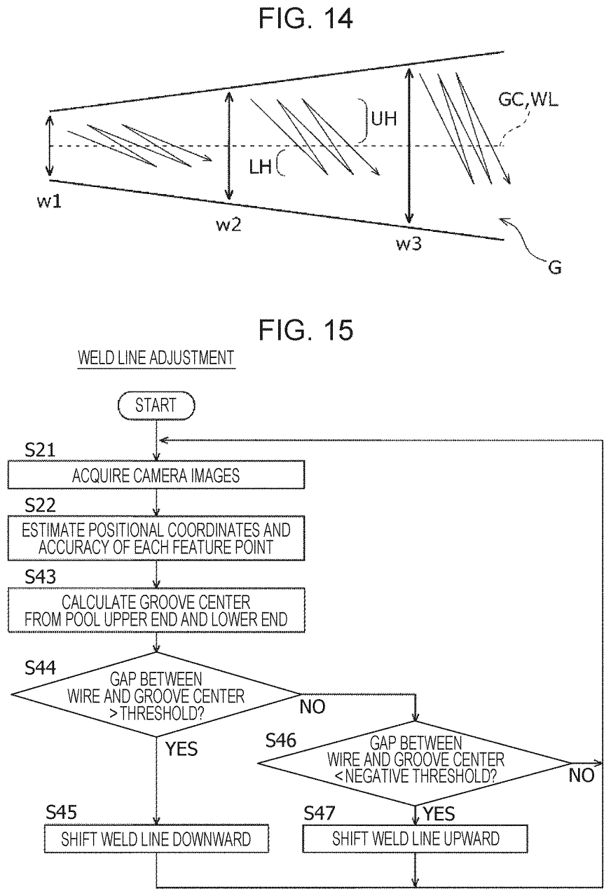

FIG. 12 is a flowchart illustrating an example of a procedure of a process according to a first modification. FIG. 13 is a diagram for explaining the process. FIG. 13A gives a general view and FIG. 13B is an enlarged view of a groove. FIG. 14 is a diagram for explaining another modification. Detailed description of the same configuration or procedure as that of the embodiment described above may be omitted by assigning the same reference numerals thereto.

First, the controller 10 acquires camera images from the camera 2 (S21). The controller 10 then estimates the positional coordinates and accuracy of each feature point in the camera image using a learned model (S22).

Next, the controller 10 calculates the width of the groove G on the basis of the detected positions of the pool upper end and the pool lower end (S33). Thus, by detecting the positions on the basis of the camera image, the change of the groove width can be followed in substantially real time. The width of the groove G may be a gap between the pool upper end and the pool lower end, or may be, for example, a value obtained by multiplying the gap by a predetermined ratio. The configuration is not limited to this. The width of the groove G may be directly calculated by extracting the edge of the workpieces U and L from the camera image.

Next, the controller 10 shifts a weld line WL upward as the calculated width of the groove G increases (S34 to S38: operation of the adjusting unit). This makes it possible to reduce sagging of the molten pool. Specifically, if the width of the groove G is less than a threshold w2 (S34: YES), the controller 10 sets a weld line WL1 on a center line GC of the groove G (S35). If the width of the groove G is greater than or equal to the threshold w2 and less than a threshold w3 (S34: NO, S36: YES), the controller 10 sets a weld line WL2 at a position above the weld line WL1 (S37). If the width of the groove G is greater than or equal to the threshold w3 (S34: NO, S36: NO), the controller 10 sets a weld line WL3 at a position above the weld line WL2 (S38). The weld line WL is a projected line along which the welding torch 31 travels to enable welding to proceed. The welding torch 31 is weaved in a front downward direction and a rear upward direction in an alternating manner, with the weld line WL at the center.

Shifting the weld line WL upward enables automatic welding even when the workpieces U and L are deformed or the groove is non-linear. In the case of using a welding robot that is not capable of asymmetrically setting the weaving width, the bridging properties of the molten pool can be properly maintained by adjusting the weaving width, with the weld line positioned at the groove center.

In addition to shifting the weld line WL upward, the controller 10 may bring the weaving angle of the welding torch 31 closer to being vertical, or may increase the weaving amplitude, as the width of the groove G increases.

The configuration is not limited to this. As illustrated in FIG. 14, with the weld line WL being kept on the center line GC of the groove G, the controller 10 may increase the proportion of an upper part UH (above the weld line WL) to a lower part LH (below the weld line WL) of the weaving width of the welding torch 31, as the width of the groove G increases. This also makes it possible to reduce sagging of the molten pool. Although the molten pool tends to sag under the influence of gravity, the bridging properties of the molten pool can be maintained by making the adjustment described above.

### [Second Modification]

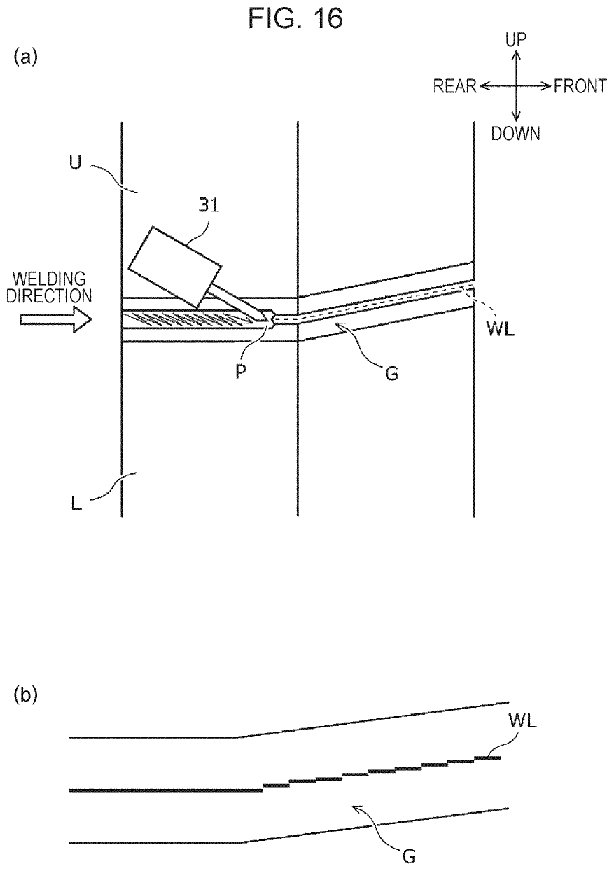

FIG. 15 is a flowchart illustrating an example of a procedure of a process according to a second modification. FIG. 16 is a diagram for explaining the process. Detailed description of the same configuration or procedure as that of the embodiment described above may be omitted by assigning the same reference numerals thereto. FIG. 16A gives a general view and FIG. 16B is an enlarged view of a groove.

First, the controller 10 acquires camera images from the camera 2 (S21). The controller 10 then estimates the positional coordinates and accuracy of each feature point in the camera image using a learned model (S22).

Next, the controller 10 calculates the center of the groove G on the basis of the detected positions of the pool upper end and the pool lower end (S43). The center of the groove G is at the midpoint between the pool upper end and the pool lower end. The configuration is not limited to this. The center of the groove G may be directly calculated by extracting the edge of the workpieces U and L from the camera image.

Next, if the gap between the detected position of the wire and the center of the groove G is greater than or equal to a threshold, the controller 10 shifts the weld line WL toward the center of the groove G (S44 to S47: operation of the adjusting unit). The position of the wire represents the position of the weld line WL. Specifically, if a difference obtained by subtracting the height of the center of the groove G from the height of the wire is greater than a positive threshold (S44: YES), that is, if the position of the wire is above the center of the groove G and the gap between them is greater than the threshold, the controller 10 shifts the weld line WL downward (S45). On the other hand, if a difference obtained by subtracting the height of the center of the groove G from the height of the wire is smaller than a negative threshold (S44: NO, S46: YES), that is, if the position of the wire is below the center of the groove G and the gap between them is greater than the threshold, the controller 10 shifts the weld line WL upward (S47). Thus, even when the groove G is inclined, for example, by welding the workpieces U and L on a plate, the weld line WL can follow the center of the groove G. Since the weld line WL is shifted only when there is large deviation, improved stability of control is achieved.

The present description discloses techniques according to various aspects. Major techniques among them will now be summarized.

An automatic welding system according to an aspect includes a welding robot configured to perform arc welding in a groove while weaving a welding torch in a front downward direction and a rear upward direction in an alternating manner when a welding direction is a frontward direction, the groove extending in a horizontal direction between two workpieces to be welded, the two workpieces being aligned in a vertical direction; a camera configured to capture an image of an arc and a molten pool produced in the groove by the arc welding; a detecting unit configured to detect a position of a leading end of the molten pool in a camera image captured by the camera; and a determining unit configured to determine the amount of correction of welding speed on the basis of a distance between the arc and the leading end of the molten pool when the distance is in a predetermined range.

An automatic welding method according to another aspect includes performing arc welding in a groove while weaving a welding torch in a front downward direction and a rear upward direction in an alternating manner when a welding direction is a frontward direction, the groove extending in a horizontal direction between two workpieces to be welded, the two workpieces being aligned in a vertical direction; capturing, with a camera, an image of an arc and a molten pool produced in the groove by the arc welding; detecting a position of a leading end of the molten pool in a camera image captured by the camera; and determining the amount of correction of welding speed on the basis of a distance between the arc and the leading end of the molten pool when the distance is in a predetermined range.

A welding assistance device according to another aspect includes an acquiring unit configured to acquire a camera image generated by a camera that captures an image of an arc and a molten pool produced in a groove by arc welding performed while a welding torch is being weaved in a front downward direction and a rear upward direction in an alternating manner when a welding direction is a frontward direction, the groove extending in a horizontal direction between two workpieces to be welded, the two workpieces being aligned in a vertical direction; a detecting unit configured to detect a position of a leading end of the molten pool in the camera image; and a determining unit configured to determine the amount of correction of welding speed on the basis of a distance between the arc and the leading end of the molten pool when the distance is in a predetermined range.

A program according to another aspect is configured to cause a computer to function as an acquiring unit configured to acquire a camera image generated by a camera that captures an image of an arc and a molten pool produced in a groove by arc welding performed while a welding torch is being weaved in a front downward direction and a rear upward direction in an alternating manner when a welding direction is a frontward direction, the groove extending in a horizontal direction between two workpieces to be welded, the two workpieces being aligned in a vertical direction; a detecting unit configured to detect a position of a leading end of the molten pool in the camera image; and a determining unit configured to determine the amount of correction of welding speed on the basis of a distance between the arc and the leading end of the molten pool when the distance is in a predetermined range.

With the techniques described above, it is possible, in horizontal welding, to keep the welding torch at a proper position with respect to the molten pool.

The present application is based on Japanese Patent Application No. 2019-208569, filed Nov. 19, 2019, and Japanese Patent Application No. 2020-137800, filed Aug. 18, 2020, the contents of which are incorporated in the present application.

To express the present invention, the present invention has been appropriately and fully described through the description of the embodiments with reference to the drawings. However, it should be understood that it is easy for those skilled in the art to change and/or modify the embodiments described above. Therefore, as long as changes or modifications made by those skilled in the art do not depart from the scope of the claimed invention, the changes and modifications are interpreted as being included in the claimed invention.

### INDUSTRIAL APPLICABILITY

The present invention can provide an automatic welding system, an automatic welding method, a welding assistance device, and a program.

1. An automatic welding system comprising:
a welding robot configured to perform arc welding in a groove while weaving a welding torch in a front downward direction and a rear upward direction in an alternating manner when a welding direction is a frontward direction, the groove extending in a horizontal direction between two workpieces to be welded, the two workpieces being aligned in a vertical direction;
a camera configured to capture an image of an arc and a molten pool produced in the groove by the arc welding;
a detecting unit configured to detect a position of a leading end of the molten pool in a camera image captured by the camera; and
a determining unit configured to determine the amount of correction of welding speed on the basis of a distance between the arc and the leading end of the molten pool when the distance is in a predetermined range.

2. The automatic welding system according to claim 1, wherein the detecting unit detects a position of the arc and the position of the leading end of the molten pool in the camera image.

3. The automatic welding system according to claim 1, wherein the position of the leading end of the molten pool is a position of a tip of an upper one of two protrusions appearing at the leading end of the molten pool, positioned one above the other, and protruding in the frontward direction.

4. The automatic welding system according to claim 1, wherein the position of the leading end of the molten pool is a position of a rear end of a recess between two protrusions appearing at the leading end of the molten pool, positioned one above the other, and protruding in the frontward direction.

5. The automatic welding system according to claim 1, wherein the determining unit determines the amount of correction on the basis of the distance between the arc and the leading end of the molten pool when the arc is in a closest range where the arc is closest to the leading end of the molten pool.

6. The automatic welding system according to claim 1, wherein the detecting unit detects a position of an upper end or a lower end of the molten pool in the camera image; and
the determining unit determines the amount of correction on the basis of the distance between the arc and the leading end of the molten pool when a distance between the arc and the upper end or lower end of the molten pool is in a predetermined range.

7. The automatic welding system according to claim 6, wherein the determining unit determines the amount of correction on the basis of the distance between the arc and the leading end of the molten pool when the arc is in a farthest range where the arc is farthest from the upper end of the molten pool or when the arc is in a closest range where the arc is closest to the lower end of the molten pool.

8. The automatic welding system according to claim 1, wherein the detecting unit estimates the position of the arc and the position of the leading end of the molten pool in the camera image by using a learned model built in advance by machine learning, the learned model being built by using a position of an arc and a position of a leading end of a molten pool in a learning image as teacher data.

9. The automatic welding system according to claim 8, wherein the detecting unit further estimates positions of an upper end and a lower end of the molten pool in the camera image by using the learned model, the learned model being built by using positions of the upper end and the lower end of the molten pool in the learning image as teacher data.

10. The automatic welding system according to claim 8, wherein the detecting unit further estimates accuracy of the leading end of the molten pool in the camera image by using the learned model, the learned model being built by using visibility of the leading end of the molten pool in the learning image as teacher data.

11. The automatic welding system according to claim 1, further comprising an adjusting unit configured to adjust a weaving angle or a weaving amplitude of the welding torch on the basis of a width of the groove.

12. The automatic welding system according to claim 1, further comprising an adjusting unit configured to shift a weld line upward as a width of the groove increases.

13. The automatic welding system according to claim 12, wherein the adjusting unit brings a weaving angle of the welding torch closer to being vertical or increases a weaving amplitude of the welding torch as the width of the groove increases.

14. The automatic welding system according to claim 1, further comprising an adjusting unit configured to increase a proportion of an upper part to a lower part of a weaving width of the welding torch as a width of the groove increases, the upper part and the lower part being above and below, respectively, of a weld line.

15. The automatic welding system according to claim 1, wherein the detecting unit detects positions of an upper end and a lower end of the molten pool in the camera image; and
the adjusting unit calculates a width of the groove on the basis of a gap between the upper end and the lower end of the molten pool.

16. The automatic welding system according to claim 1, further comprising an adjusting unit configured to cause a weld line to follow a center of the groove.

17. The automatic welding system according to claim 16, wherein the adjusting unit shifts the weld line toward the center of the groove when a gap between the center of the groove and the weld line is greater than or equal to a threshold.

18. The automatic welding system according to claim 16, wherein the detecting unit detects a position of a wire in the camera image; and
the adjusting unit shifts the weld line toward the center of the groove when a gap between the center of the groove and the position of the wire in an up-down direction is greater than or equal to a threshold.

19. The automatic welding system according to claim 16, wherein the detecting unit detects positions of an upper end and a lower end of the molten pool in the camera image; and
the adjusting unit calculates the center of the groove on the basis of the positions of the upper end and the lower end of the molten pool.

20. An automatic welding method comprising:
performing arc welding in a groove while weaving a welding torch in a front downward direction and a rear upward direction in an alternating manner when a welding direction is a frontward direction, the groove extending in a horizontal direction between two workpieces to be welded, the two workpieces being aligned in a vertical direction;
capturing, with a camera, an image of an arc and a molten pool produced in the groove by the arc welding;
detecting a position of a leading end of the molten pool in a camera image captured by the camera; and
determining the amount of correction of welding speed on the basis of a distance between the arc and the leading end of the molten pool when the distance is in a predetermined range.

21. A welding assistance device comprising:
an acquiring unit configured to acquire a camera image generated by a camera that captures an image of an arc and a molten pool produced in a groove by arc welding performed while a welding torch is being weaved in a front downward direction and a rear upward direction in an alternating manner when a welding direction is a frontward direction, the groove extending in a horizontal direction between two workpieces to be welded, the two workpieces being aligned in a vertical direction;
a detecting unit configured to detect a position of a leading end of the molten pool in the camera image; and
a determining unit configured to determine the amount of correction of welding speed on the basis of a distance between the arc and the leading end of the molten pool when the distance is in a predetermined range.

22. A program configured to cause a computer to function as:
an acquiring unit configured to acquire a camera image generated by a camera that captures an image of an arc and a molten pool produced in a groove by arc welding performed while a welding torch is being weaved in a front downward direction and a rear upward direction in an alternating manner when a welding direction is a frontward direction, the groove extending in a horizontal direction between two workpieces to be welded, the two workpieces being aligned in a vertical direction;
a detecting unit configured to detect a position of a leading end of the molten pool in the camera image; and
a determining unit configured to determine the amount of correction of welding speed on the basis of a distance between the arc and the leading end of the molten pool when the distance is in a predetermined range.
